(19) United States
(12) Patent Application Publication
(10) Pub. No.: US 2017/0094400 A1
(43) Pub. Date: Mar. 30, 2017

(54) HEADSET DEVICE, HEADPHONE COVER DEVICE AND ASSOCIATED METHODS

(71) Applicant: Daniel D. Willman, Marathon, FL (US)

(72) Inventor: Daniel D. Willman, Marathon, FL (US)

(21) Appl. No.: 14/871,268

(22) Filed: Sep. 30, 2015

(51) Int. Cl. H04R 1/10; H04R 1/32; H04R 1/08

(52) U.S. Cl. CPC H04R 1/1058; H04R 1/1008; H04R 1/08; H04R 1/326

(57) ABSTRACT

A headset device having a first headphone, a second headphone, a headband, a first headphone cover, and a second headphone cover. The headband connects the first headphone and the opposing second headphone. The first and second headphone covers removably connect to the first and second headphones, respectively. Each of the first headphone cover and the second headphone cover has a rear portion and a passageway. The rear portion has an engagement portion adapted to engage a mount portion of a respective one of the first headphone or second headphone to allow for a respective one of the first headphone cover or second headphone cover to be secured to a respective one of the first headphone or second headphone. The passageway, sized to receive a temple tip of an eyeglasses frame, is formed through a top portion and extending through a first side portion.

### FIELD OF THE INVENTION

The present invention relates to systems and devices for providing ear coverings. More specifically, the present invention provides a headset system adapted to retain eyewear temples while maintaining the integrity of a seal formed around the ear.

### BACKGROUND

People often wish to use headset equipment, for example headphones, earmuffs, or noise canceling headsets. However, for people who wear glasses or sunglasses, the headsets often interfere with the earpieces or temples of the glasses with the result that it is uncomfortable for the audio or hands free equipment to be used whilst wearing glasses, for example because the headphones tend to push the earpieces or temples of the glasses inwardly against the sides of the user's head. Additionally, the introduction of the temple between the wearer's body and the headset compromises any acoustic seal that may be created by the design of the headset.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

With the above in mind, embodiments of the present invention are related to a headset device having a first headphone, a second headphone, a headband, a first headphone cover, and a second headphone cover. The second headphone opposes the first headphone. The headband connects the first headphone and the second headphone. The first headphone cover removably connects to the first headphone. The second headphone cover removably connects to the second headphone opposing the first headphone cover. Each of the first headphone cover and the second headphone cover has a rear portion and a passageway. The rear portion has an engagement portion adapted to engage a mount portion of a respective one of the first headphone or second headphone to allow for a respective one of the first headphone cover or second headphone cover to be secured to a respective one of the first headphone or second headphone. The passageway, which is sized to receive a temple tip of an eyeglasses frame, is formed through a top portion and extends through a first side portion.

The headset device passageway may extend through the entirety of the top portion from the first side portion to a second side portion. Each of the first headphone cover and the second headphone cover may have an outer perimeter and an inner perimeter. The passageway may have a forward passage formed to extend from the outer perimeter of the first side portion to the inner perimeter of the first side portion.

The passageway may further have a rear passage formed to extend from the inner perimeter of a second side portion to the outer perimeter of the second side portion. The headset device may further have a structural member, sized to receive a temple tip of an eyeglasses frame, disposed within the passageway.

The structural member may extend through an entirety of the passageway from the first side portion to a second side portion. The passageway may have a forward passageway formed to extend from the outer perimeter of the first side portion to the inner perimeter of the first side portion. The passageway may have a rear passage formed to extend from the inner perimeter of the second side portion to the outer perimeter of the second side portion. The headset device may further have a structural member cover to overlie the structural member and extend between the inner perimeter of the first side portion and the inner perimeter of the second side portion.

The headset device may further have a temple tip guide, having a size substantially similar to the passageway, extending outwardly from an outer perimeter of the first side portion of each of the first and second headphone covers. The temple tip guide may have a tapered end.

The headphone cover may have a rear portion and a passageway. The rear portion may have an engagement portion adapted to engage a mount portion of a headphone to allow for the headphone cover to be secured thereto. The passageway, which may be sized to receive a temple tip of an eyeglasses frame, may be formed through a top portion and extend through a first side portion.

The headset device may have a first headphone, a second headphone, a headband, a microphone boom, a microphone, a first headphone cover, and a second headphone cover. The first headphone has a first speaker. The second headphone opposes the first headphone and has a second speaker. The headband connects the first headphone and the second headphone. The microphone boom may connect to one of the first or second headphones. The microphone is connected to an end portion of the microphone boom. The microphone boom is moveable so that the microphone is positionable adjacent to a user's mouth. The first headphone cover may be removably connected to the first headphone. The second headphone cover opposes the first headphone cover and may be removably connected to the second headphone. Each of the first headphone cover and the second headphone cover have a rear portion, a passageway, and a structural member. The rear portion has an engagement portion adapted to engage a mount portion of either the first headphone or second headphone to allow for one of the first headphone cover or second headphone cover to be secured thereto. The passageway may be sized to receive a temple tip of an eyeglasses frame, and may be formed through a top portion and extends through the entirety of a top portion from a first side portion to a second side portion. The structural member is disposed within the passageway and sized to receive a temple tip of an eyeglasses frame.

### BRIEF DESCRIPTION OF THE DRAWINGS

FIG. 1 is a perspective side view of a headset device according to an embodiment of the present invention.

FIG. 2 is a front elevation view of the headset device of FIG. 1.

FIG. 3 is a rear elevation view of the headset device of FIG. 1.

FIG. 4 is a left side elevation view of the headset device of FIG. 1.

FIG. 5 is a right side elevation view of the headset device of FIG. 1.

FIG. 6 is a top plan view of the headset device of FIG. 1.

FIG. 7 is a bottom plan view of the headset device of FIG. 1.

FIG. 8 is an environmental view of a user wearing eyewear interfacing with the headset device according to an embodiment of the present invention.

FIG. 9 is a perspective side view of a headset device of FIG. 8.

FIG. 10 is a front elevation view of the headset device of FIG. 8.

FIG. 11 is a rear elevation view of the headset device of FIG. 8.

FIG. 12 is a left side elevation view of the headset device of FIG. 8.

FIG. 13 is a right side elevation view of the headset device of FIG. 8.

FIG. 14 is a top plan view of the headset device of FIG. 8.

FIG. 15 is a bottom plan view of the headset device of FIG. 8.

FIG. 16 is a perspective side view of a headphone cover of the headset device of FIG. 1.

FIG. 17 is a left side elevation view of the headphone cover of FIG. 16.

FIG. 18 is a right side elevation view of the headphone cover of FIG. 16.

FIG. 19 is a rear elevation view of the headphone cover of FIG. 16.

FIG. 20 is a front elevation view of the headphone cover of FIG. 16.

FIG. 21 is a top plan view of the headphone cover of FIG. 16.

FIG. 22 is a bottom plan view of the headphone cover of FIG. 16.

FIG. 23 is a perspective side view of a headphone cover of the headset device of FIG. 9.

FIG. 24 is a left elevation side view of the headphone cover of FIG. 23.

FIG. 25 is a right elevation side view of the headphone cover of FIG. 23.

FIG. 26 is a rear elevation view of the headphone cover of FIG. 23.

FIG. 27 is a front elevation view of the headphone cover of FIG. 23.

FIG. 28 is a top plan view of the headphone cover of FIG. 23.

FIG. 29 is a bottom plan view of the headphone cover of FIG. 23.

FIGS. 30A-30C are side views of possible embodiments of prior art temples.

FIG. 31 is a perspective side view of the headset device with the headset cover removed in accordance with an embodiment of the invention.

FIG. 32 is a front view of a headphone cover in accordance with an embodiment of the invention.

FIG. 33 is a perspective side view of the headset device according to an embodiment of the present invention.

FIG. 34 is a perspective side view of a headphone cover of the headset device according to an embodiment of the present invention.

FIG. 35 is a side plan view of a structural member according to an embodiment of the present invention.

FIG. 36 is a side plan view of a structural member according to an embodiment of the present invention.

FIG. 37 is a side plan view of the structural member of FIG. 36 in combination with eyewear.

FIG. 38 is a side plan view of the structural member of FIG. 35 in combination with eyewear.

FIG. 39 is a side plan view of a structural member according to an embodiment of the present invention.

FIG. 40 is a side plan view of the structural member of FIG. 39 in combination with eyewear.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

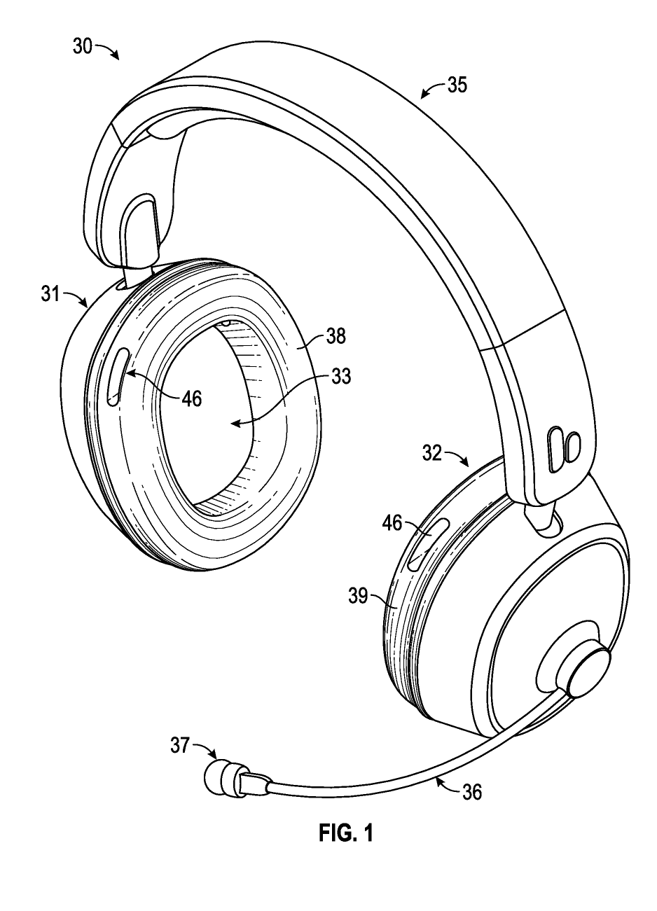

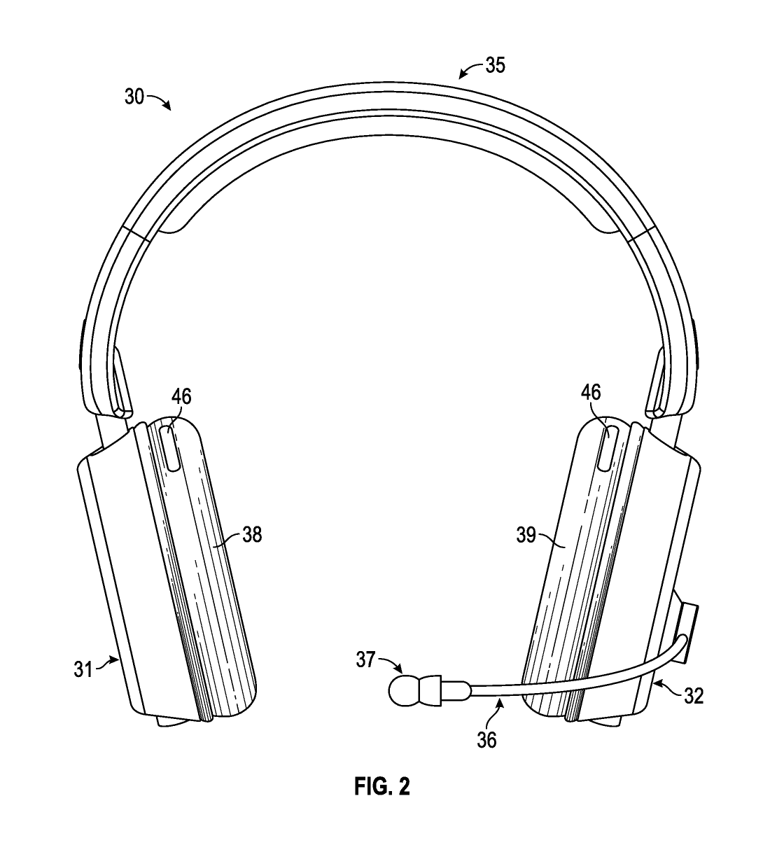

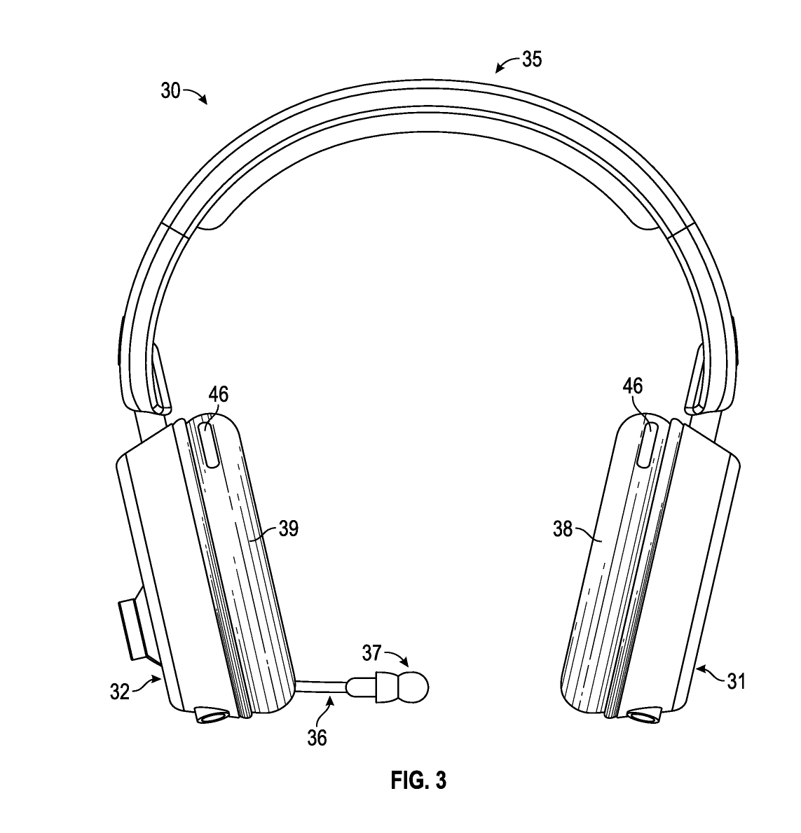

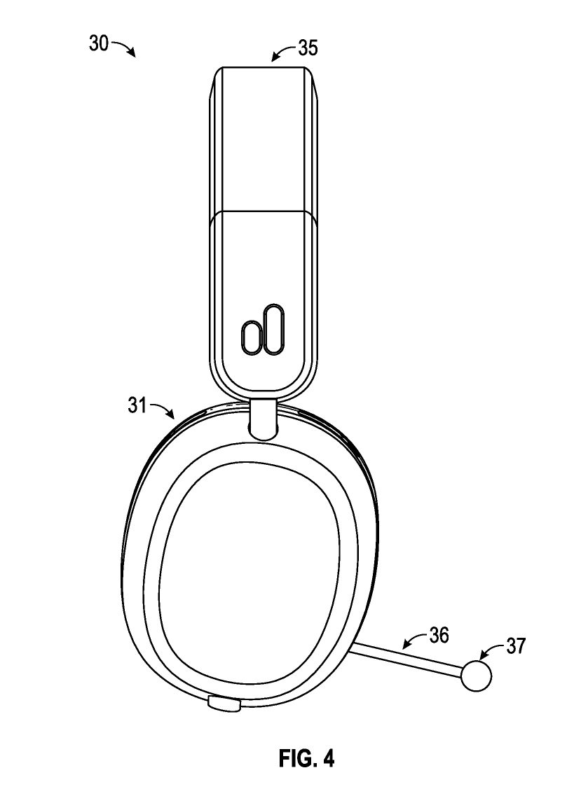

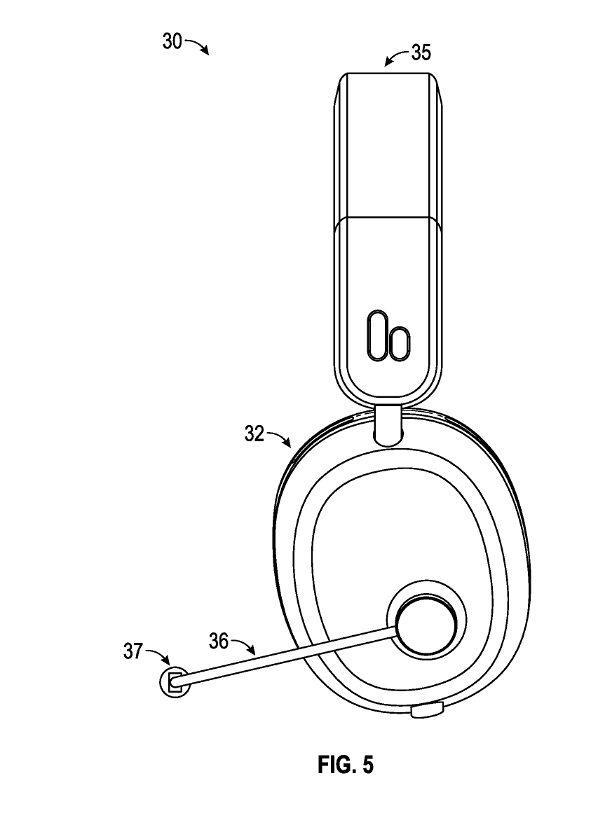

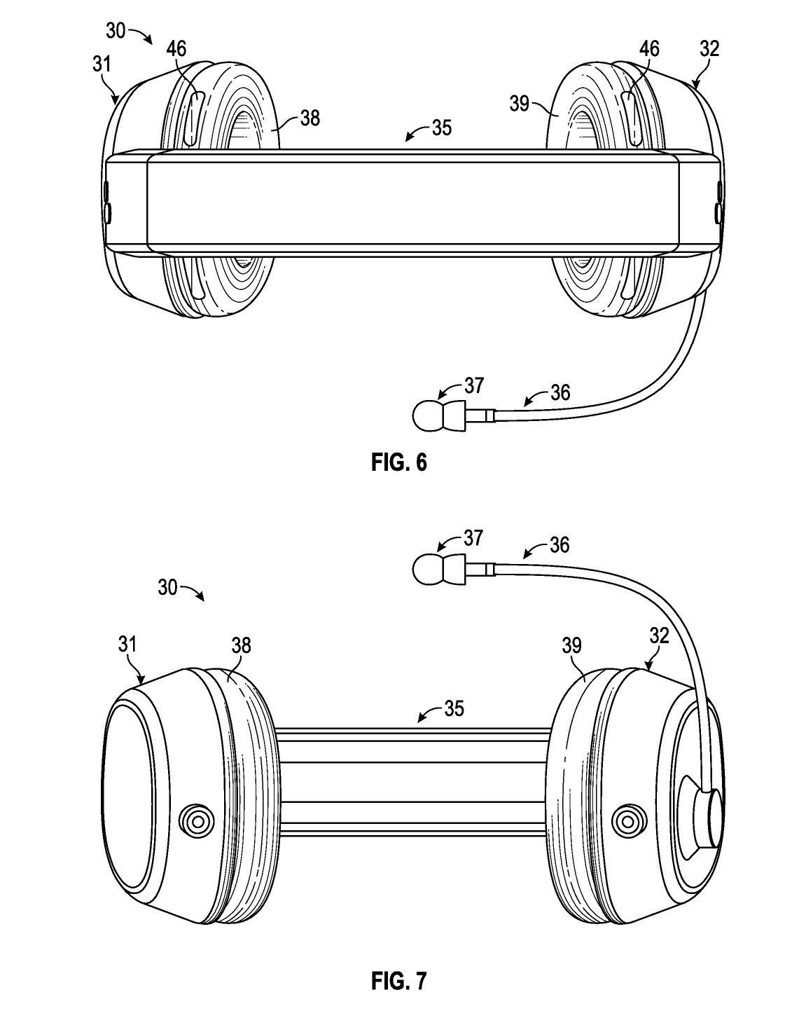

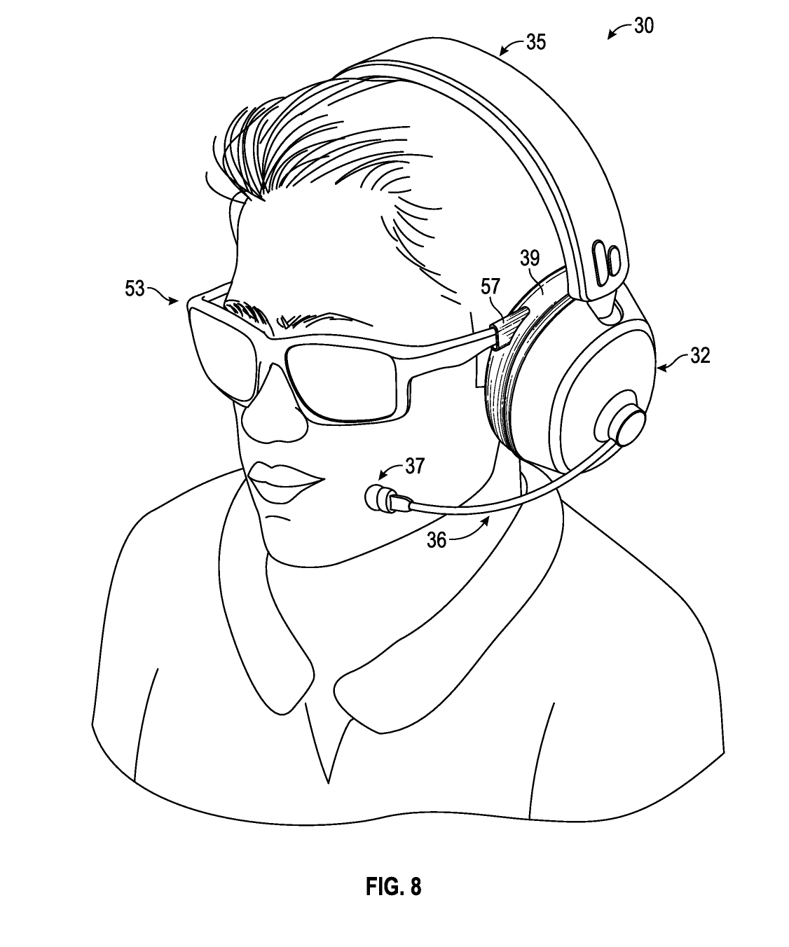

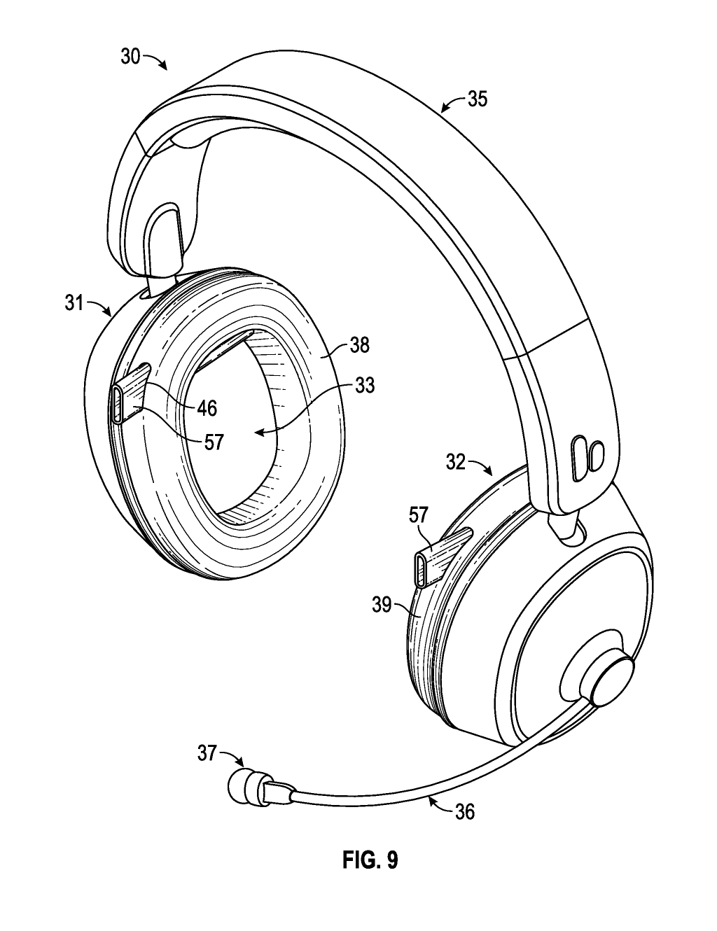

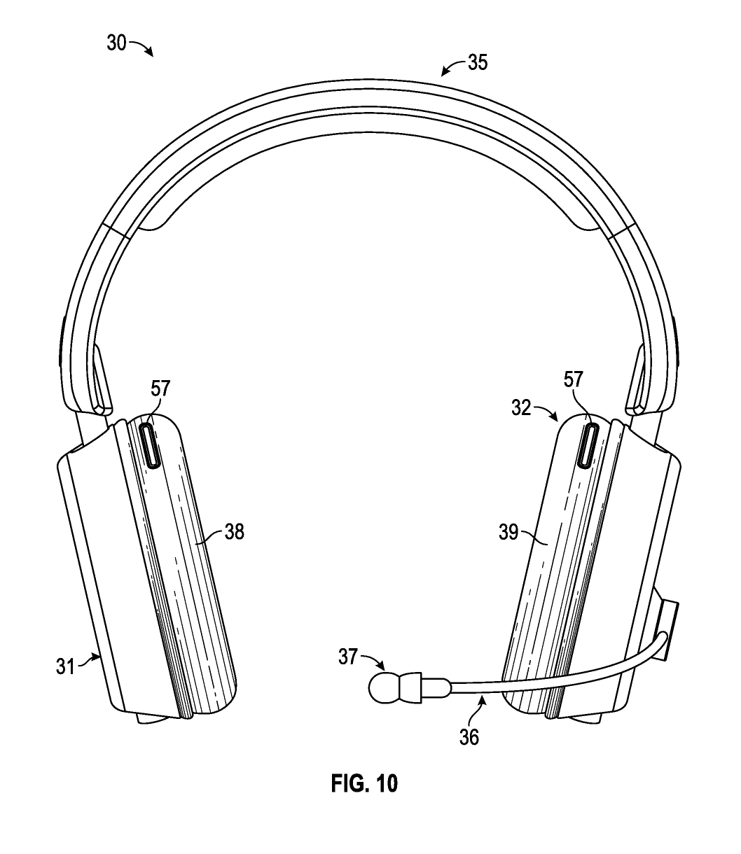

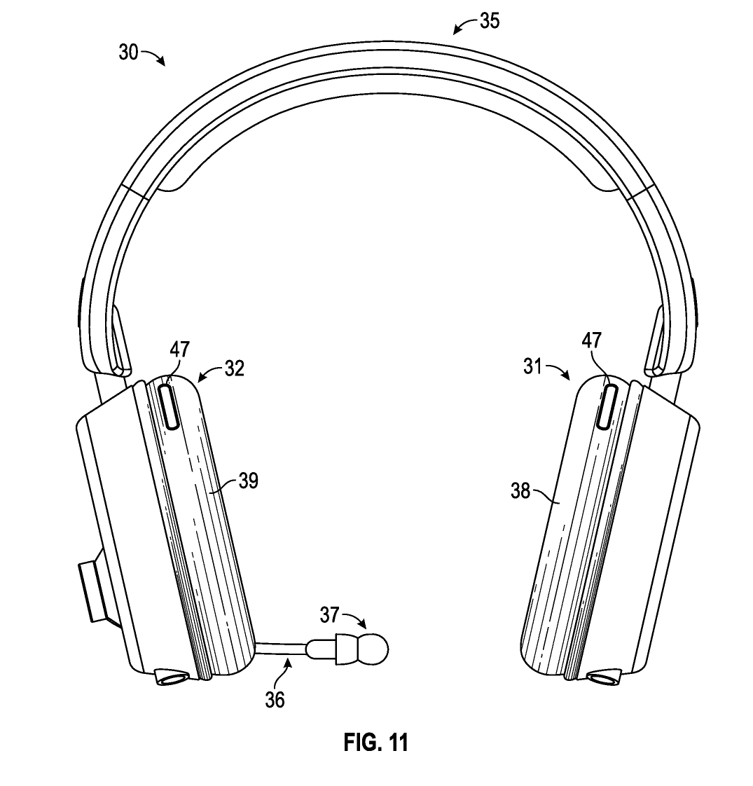

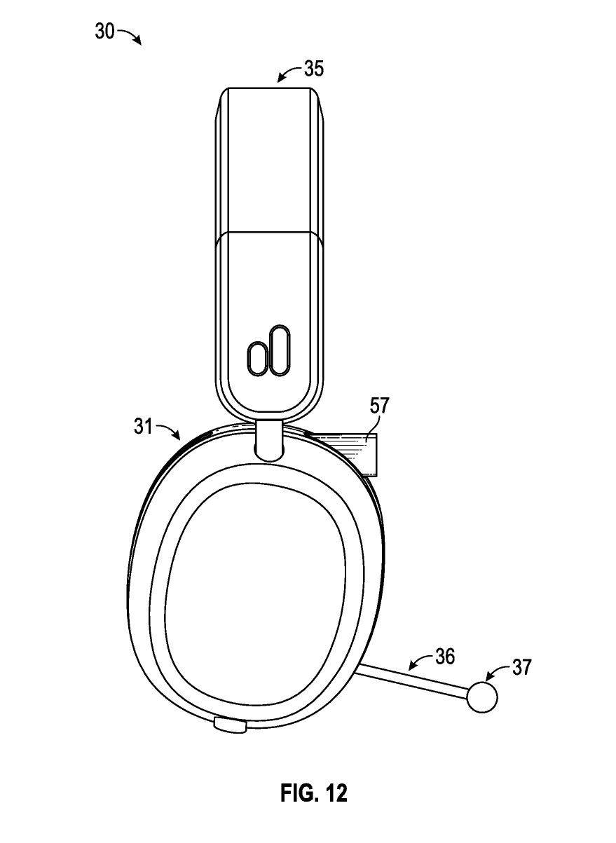

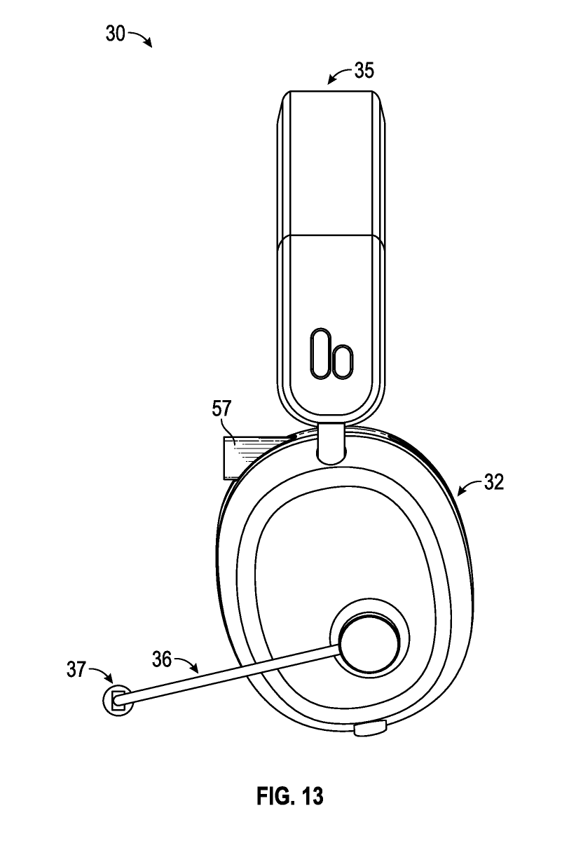

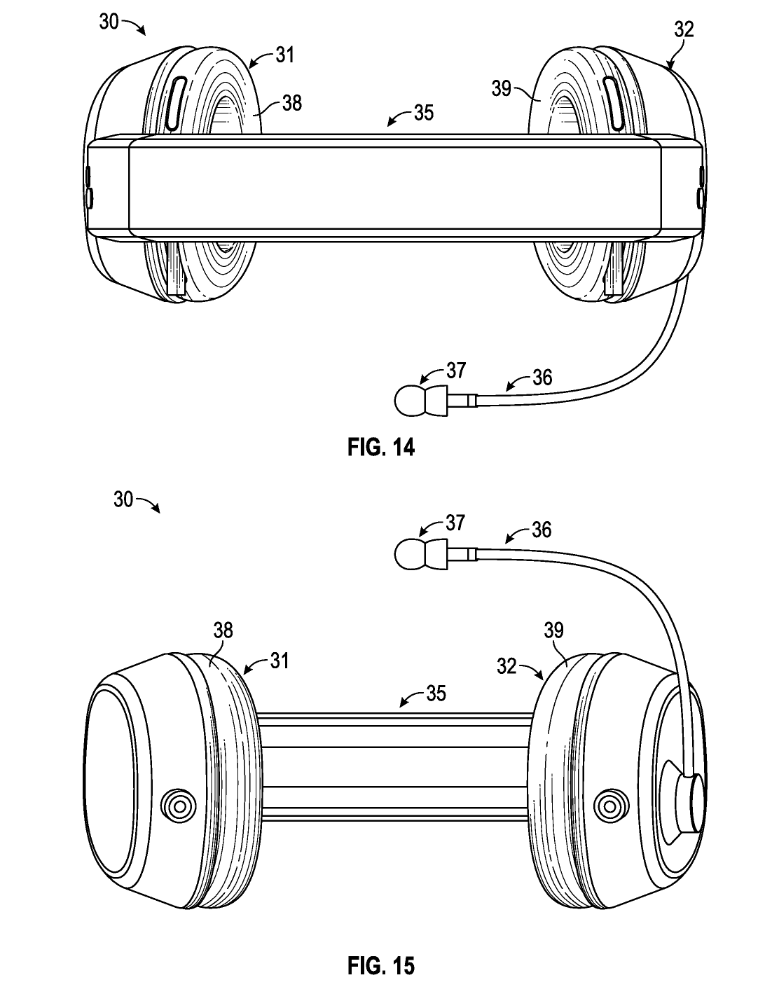

An embodiment of the invention, as shown and described by the various figures and accompanying text, provides a headset device 30. As shown in FIG. 1, the headset device 30 may have a first headphone 31 and a second headphone 32. The first headphone 31 and the second headphone 32 may be any number of specific ear coverings connected by a headband 35 and adapted to be worn over a user's ears. The first headphone 31 may be connected to a first end of the headband 35. The second headphone 32 may be connected to a second end of the headband 35 and may oppose the first headphone 31. As shown in FIG. 8, the first and second headphones 31, 32 may have an inner side adapted to be located adjacent a user's ears when worn by a user. The first and second headphones 31, 32 may have an outer side opposing the inner side. The first headphone 31 and the second headphone 32 may include ear coverings worn by pilots, hearing protection devices, ear coverings with speakers adapted to provide audio only to the user wearing the ear covering, ear coverings adapted to block noise reaching a user's ears, or the like. The present invention is meant to encompass any device used to cover a user's ears in a manner to form a seal so as to prevent external noise from entering or internal noise from exiting. Although an aviation headset is illustrated in FIG. 8, those skilled in the art will appreciate that the present invention is meant to include any similar device used to form a seal adjacent to a user's ear as described above.

Each of the respective first and second headphone's 31, 32 may have a respected first and second headphone cover 38, 39. The first headphone cover 38 may oppose the second headphone cover 39. The first headphone cover 38 may removably connect to the first headphone 31. The second headphone cover 39 may removably connect to the second headphone 32. The headphone covers 38, 39 may be fixedly attached to the headphones 31, 32. The first and second headphone covers 38, 39 may be referred to as removably connected to the first headphones 31, 32 if they are not formed as a monolithic unit. The headphone covers 38, 39 may be secured to an inner side of the headphones 31, 32 and be adapted to form an acoustic seal around a user's ears when the headset device 30 is worn by the user. The headphone cover may be referred to as an ear seal, a cover, or the like. The headphone cover may comprise a cushioned surface, padded surface, or the like. The headphone cover may increase the comfort of the headset device 30 when worn by the user.

Each headphone cover 38, 39 may have a first side portion 44. The first side portion 44 of each of the first headphone cover 38 and second headphone cover 39 may be the surface of the headphone cover 38, 39 that is visible when viewed from the left as depicted in FIGS. 17 and 24. The first side portion 44 of each of the respective first headphone cover 38 and second headphone cover 39 may be the portion of each respective headphone cover 38, 39 to the left of a midline of the headphone cover 38, 39 when viewed from the front as depicted in FIGS. 20 and 27.

Each headphone cover 38, 39 may have a second side portion 45. The second side portion 45 of each of the first headphone cover 38 and second headphone cover 39 may be the surface of the headphone cover 38, 39 that is visible when viewed from the right as depicted in FIGS. 18 and 25. The second side portion 45 of each of the respective first headphone cover 38 and second headphone cover 39 may be the portion of each respective headphone cover 38, 39 to the right of a midline of the headphone cover 38, 39 when viewed from the front as depicted in FIGS. 20 and 27. The second side portion 45 may oppose the first side portion 44.

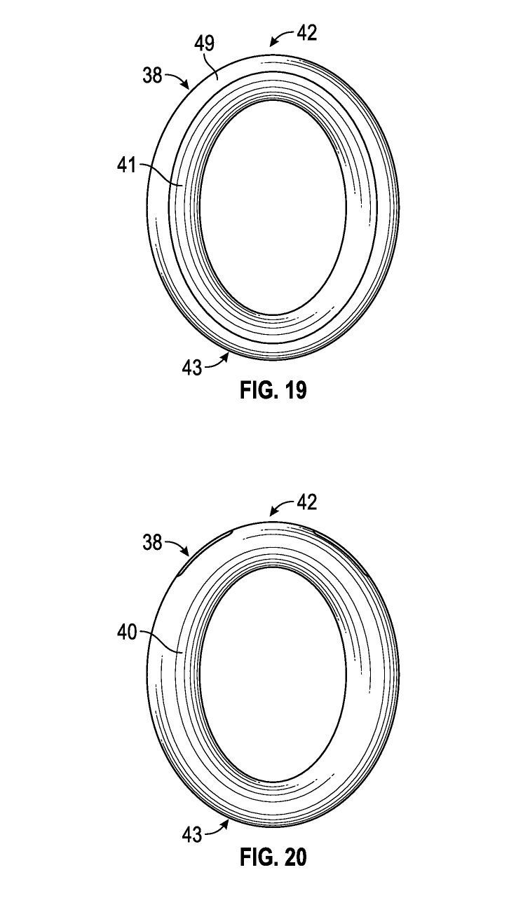

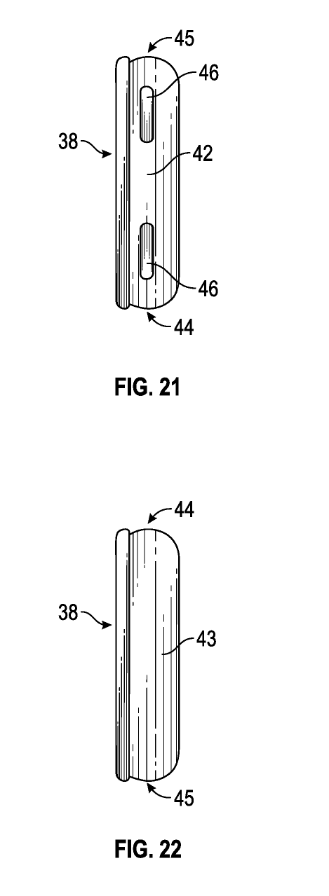

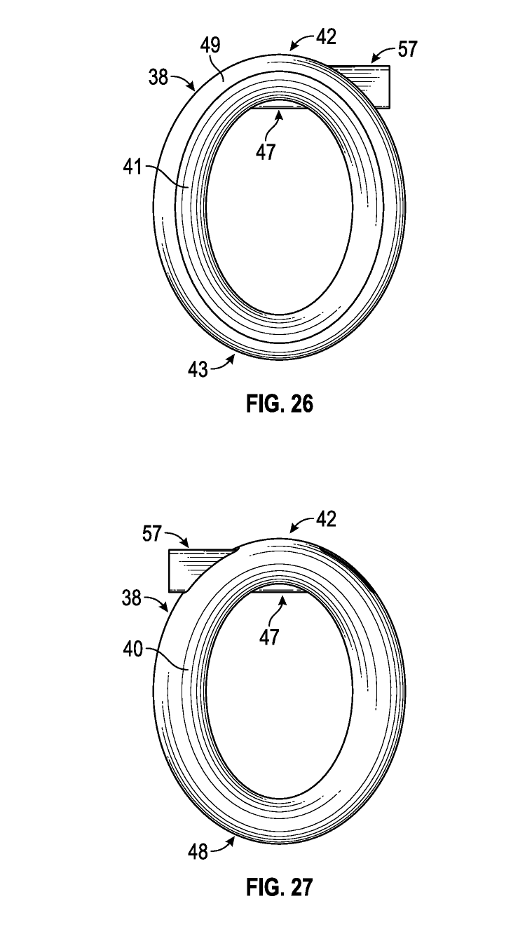

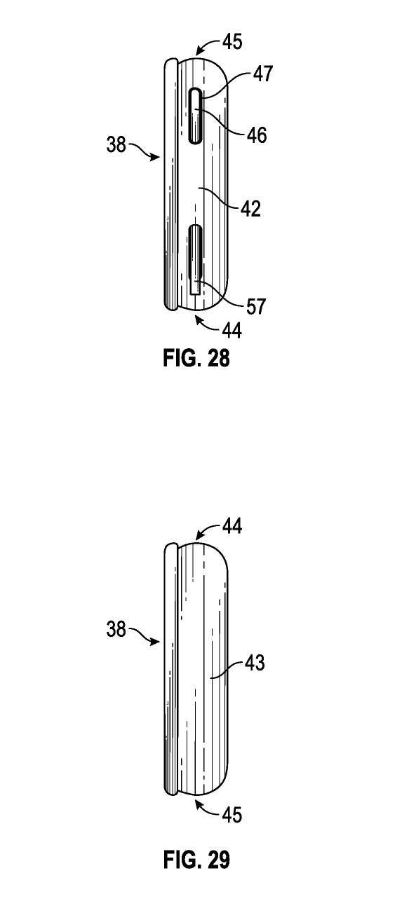

Each headphone cover 30, 39 have a top portion 42. The top portion 42 of each of the first headphone cover 38 and second headphone cover 39 may be the surface of the headphone cover 38, 39 that is visible when viewed from the top as depicted FIGS. 21 and 28. The top portion 42 of each of the respective first headphone cover 38 and second headphone cover 39 may be the portion of each respective headphone cover 38, 39 above a midline of the headphone cover 38, 39 when viewed from the front as depicted in FIGS. 20 and 27.

Each headphone cover 30, 39 may have a bottom portion 43. The bottom portion 43 of each of the first headphone cover 38 and second headphone cover 39 may be the surface of the headphone cover 38, 39 that is visible when viewed from the bottom as depicted in FIGS. 22 and 29. The bottom portion 43 of each of the respective first headphone cover 38 and second headphone cover 39 may be the portion of each respective headphone cover 38, 39 below a midline of the headphone cover 38, 39 when viewed from the front as depicted in 20 and 27. FIGS.

Each headphone cover 38, 39 may have a front portion 40. The front portion 40 of each first headphone cover 38 and second headphone cover 39 may be the surface of the headphone cover 38, 39 that is visible when viewed from the front as depicted in FIGS. 20 and 27. The front portion 40 of each of the respective first headphone cover 38 and second headphone cover 39 may be the portion of each respective headphone cover 38, 39 to the right of a midline of the headphone cover 38, 39 when viewed from the left as depicted in FIGS. 17 and 24.

Each headphone cover 38, 39 may have a rear portion 41. The rear portion 41 of each of the respective first headphone cover 38 and second headphone cover 39 may be the surface of the headphone cover 38, 39 and is visible when viewed from the back as depicted in FIGS. 19 and 26. The rear portion 41 of each of the respective first headphone cover 38 and second headphone cover 39 may be the portion of each respective headphone cover 38, 39 to the left of a midline of the headphone cover 38, 39 when viewed from the left as depicted in FIGS. 17 and 24. The rear portion 41 may oppose the front portion 40.

The rear portion 41 may be adapted to be located adjacent the headphone when the headphone cover is secured to the headphone. The rear portion 41 may have an engagement portion 49 disposed thereon. The engagement portion 49 may be a flexible flange located around the perimeter of the headphone cover, a portion of the rear portion 41 adapted to secure to the headphone, or a portion of the rear portion 41 adapted to be retained by, carried by, or the like by the headphone. The engagement portion may be disposed along all or a portion of the perimeter. The engagement portion 49 may be secured to an outer perimeter of the rear portion 41 and extend inwardly toward the center of the rear portion 41. The inner portion of the engagement portion 49 may not be secured to the rear portion 41. Such a configuration may form a pocket between the engagement portion 49 and the rear portion 41. This pocket may be adapted to carry at least a portion of a headphone. Each respective first headphone cover 38 and second headphone cover 39 may have an engagement portion 49.

As depicted in FIG. 31, the portion of the headphone carried by or adjacent the engagement portion 49 of the rear portion 41 may be a mount portion 50. The mount portion 50 may be secured to the engagement portion 49. Each respective first headphone 31 and second headphone 32 may have a mount portion 50. The mount portion 50 may be a flange adapted to be carried by the engagement portion 49. The mount portion 50 may be a surface adapted to secure the engagement portion 49. Adhesives may be disposed on the mount portion 50 to secure the engagement portion 49.

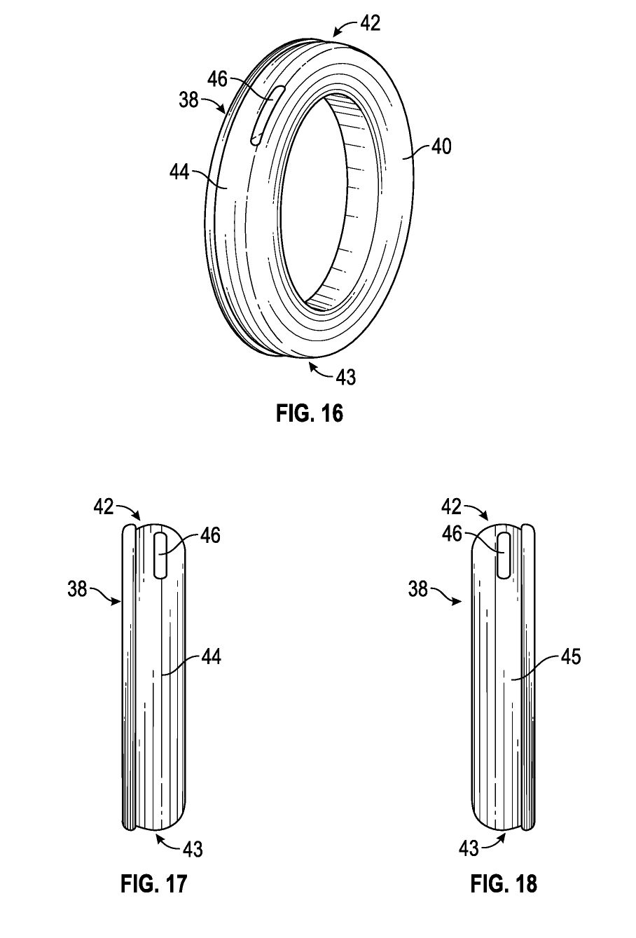

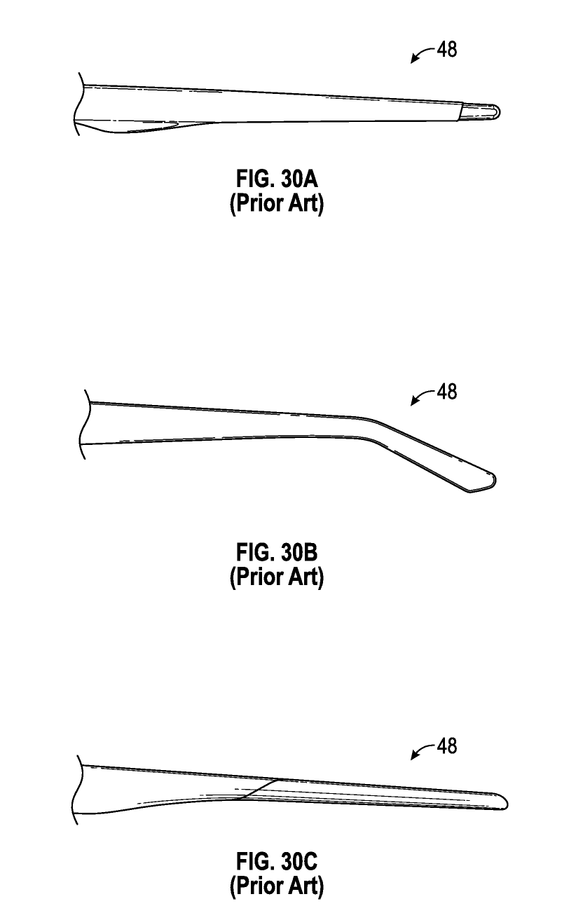

As shown at least in FIG. 16, each of the respective first headphone cover 38 and second headphone cover 39 may have a passageway 46. The passageway 46 may be sized to receive at least a portion of an eye glasses frame temple. A temple may have a tip and a medial portion. The temple tip 48 may be the portion of the temple distal from the frame. The temple tip 48 may be inserted into the passageway 46. The passageway 46 may be sized to receive the temple tip 48 and at least a portion of the medial section of the temple. At least a portion of the temple may be carried by the passageway 46. As depicted in FIG. 30A, the temple may be tapered. A tapered temple may have a temple tip with a smaller cross-section perimeter than a portion of the temple distal the temple tip. As show in FIGS. 30A-C, the temple may be square, rounded, tapered, or the like.

The passageway 46 may be formed through a top portion of the headphone. The passageway 46 may extend through at least a portion of a first side portion 44 of each of the respective first headphone 31 and second headphone 32. The passageway 46 may extend through the entirety of the top portion 42 from the first side portion 44 to the second side portion 45. When the headset device 30 is worn by a user, the passageway 46 may be configured and located on the headphone covers 38, 39 to allow the temple of eyeglasses worn by the user to enter the passageway 46.

Each headphone cover may have an inner perimeter and an outer perimeter. The outer perimeter may be the external perimeter of the headphone cover. The inner perimeter may define a void in which the user's ear may be disposed when the headset device 30 is worn by a user. A soft, or cushioned, material may be between the inner and outer perimeter. A rear portion of the material located between the inner and outer perimeter may contact the user's head when the headset device 30 is worn by user.

The passageway 46 may be only a forward passage. The forward passage may extend through the outer perimeter of the first side portion 44 to the inner perimeter of the first side portion 44. The forward passage may extend through the inner perimeter of the first side portion 44. The forward passage may terminate in the first side portion 44 before reaching the inner perimeter.

The passageway 46 may be forward passage and rear passage. The rear passage may extend through the inner perimeter of the second side portion 45 to the outer perimeter of the second side portion 45. The rear passage may extend through the outer perimeter of the second side portion 45. The rear passage may terminate in the second side portion 45 before reaching the outer perimeter.

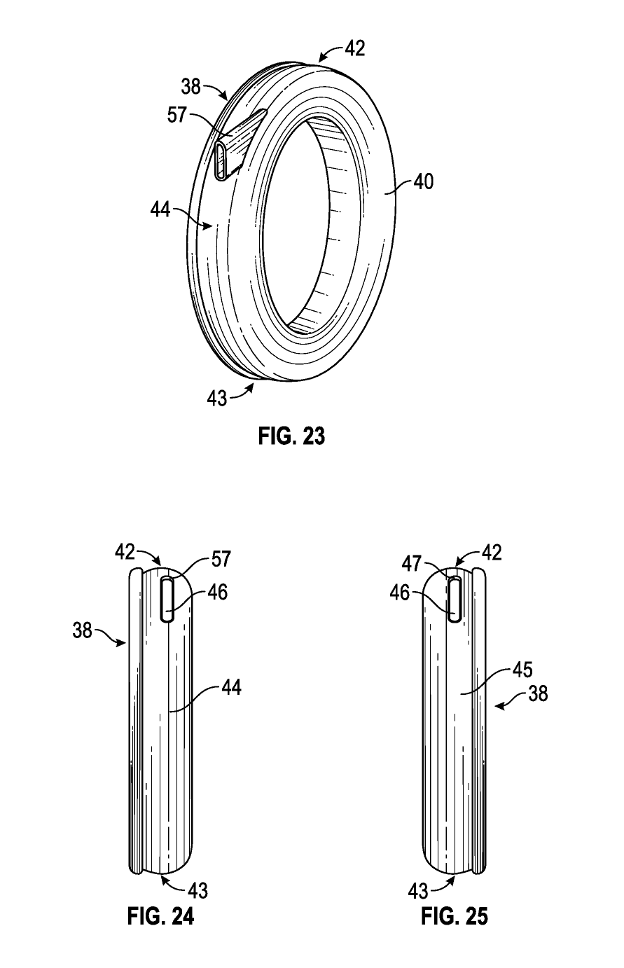

As shown at least in FIG. 23, a structural member 47 may be disposed within the passageway 46. The structural member 47 may be sized to receive a temple tip 48 of an eye glasses frame. The structural member 47 may be rigid. The structural member 47 may be adapted to serve as a guide for a temple tip 48 through the passageway. The structural member 47 may be flexible. The structural member 47 may conform to the shape of a temple inserted through the structural member 47.

The structural member 47 may pass through the first side portion 44 of the headphone cover 38, 39. The structural member 47 may extend through the entirety of the passageway 46. The structural member 47 may extend through the headphone cover 38, 39 from the first side portion 44 to the second side portion 45. The structural member 47 may extend through the second side portion 45.

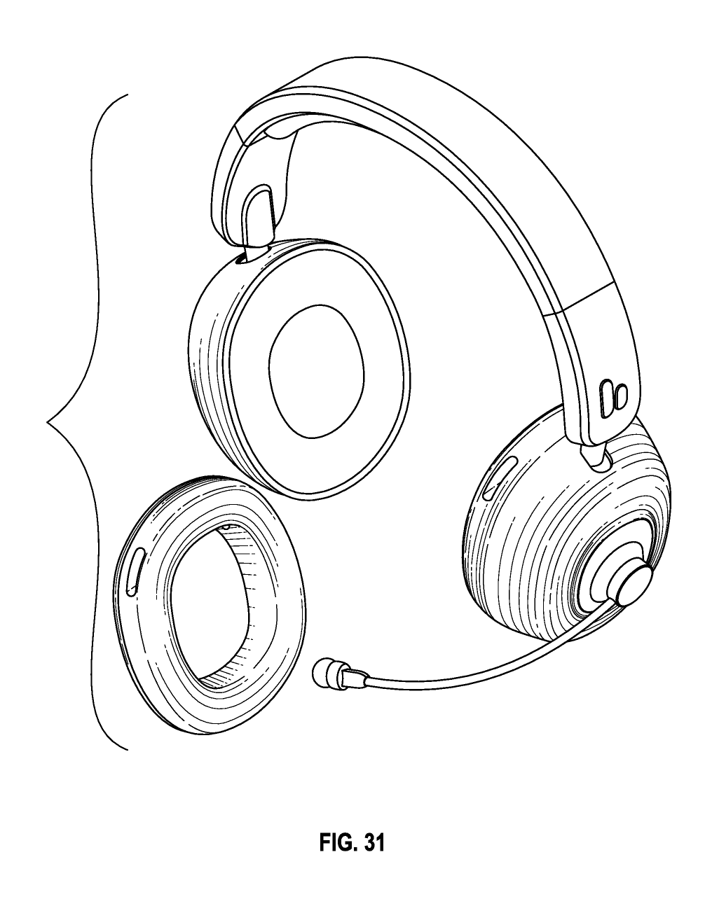

As, shown in FIG. 32, a structural member cover 56 may overlie the structural member 47 and extend between the inner perimeter of the first side portion and the inner perimeter of the second side portion. The structural member cover may be integrated with the structural member 47. The structural member cover may be formed in a monolithic unit with the front portion 40 of the headphone cover.

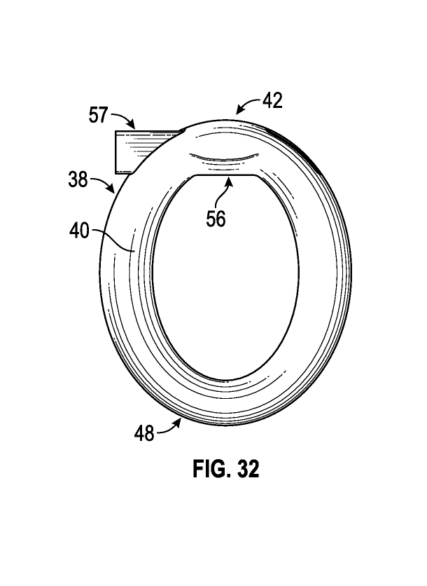

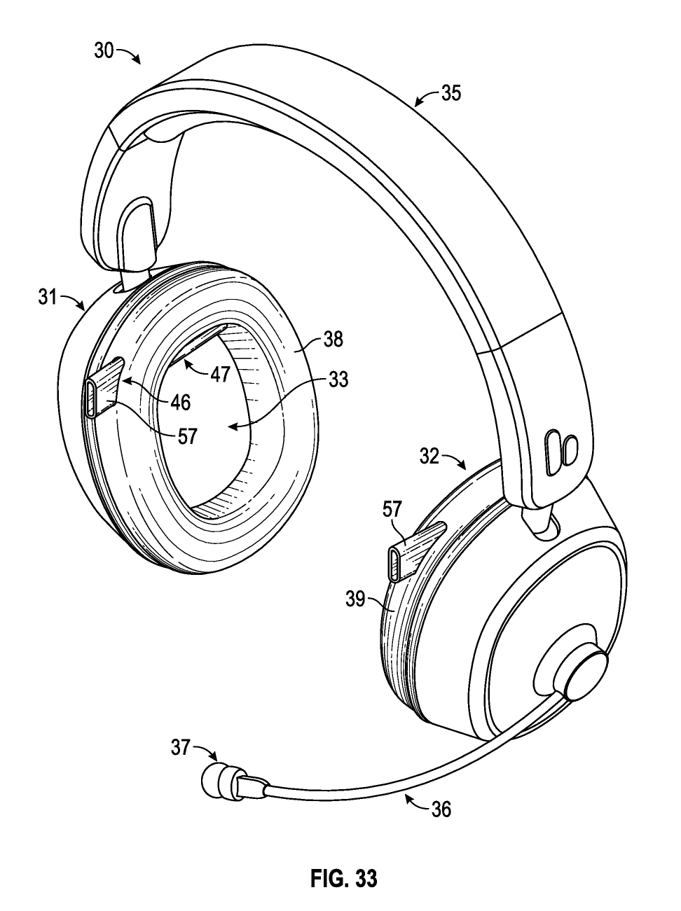

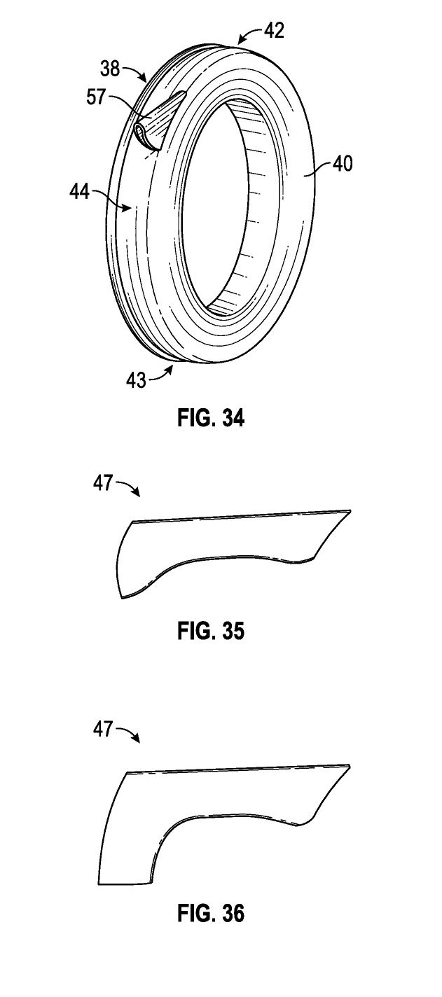

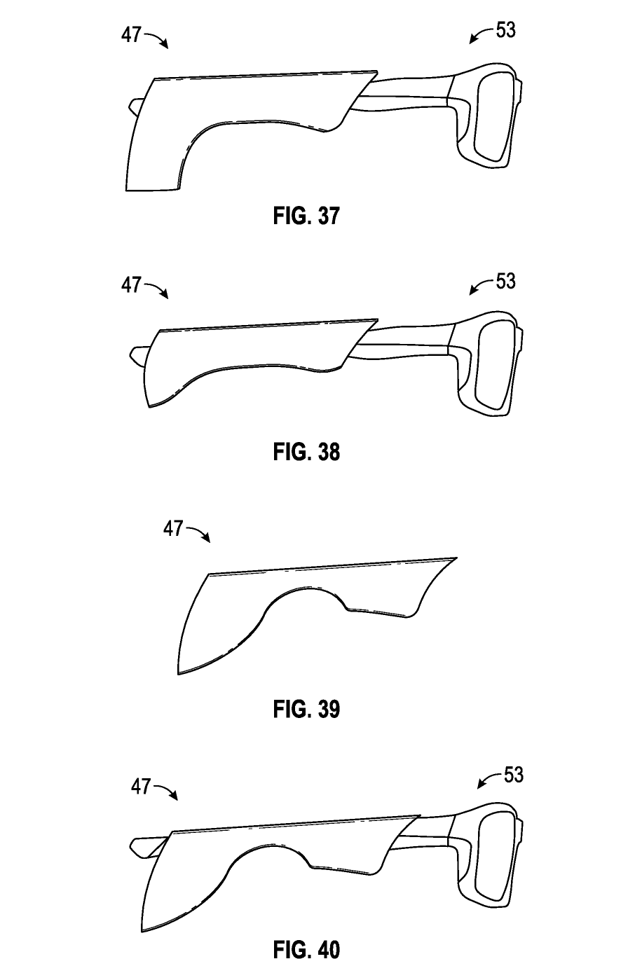

A temple tip guide 57 may extend outwardly from an outer perimeter of the first side portion 44. The temple tip guide 57 may have a size substantially similar to the passageway 46 formed in the headphone cover or the structural member 47 disposed within the passageway 46. A substantially similar size may mean that the temple tip guide 57 may be retained securely within the passageway 46 or adjacent the structural member 47 disposed within the passageway 46. A substantially similar size may mean that the outer perimeter of the temple tip guide 57 may fit within the inner perimeter of the passageway 46 or adjacent the structural member 47. A substantially similar size may mean that the temple tip guide 57 is longer than the passageway 46. As shown in FIG. 34, the temple tip guide 57 may have a tapered end. As depicted, the tapered end of the temple tip guide 57 is tapered on the bottom of the temple tip guide 57. However, the temple tip guide 57 may be tapered on the top or side.

Some of the illustrative aspects of the present invention may be advantageous in solving the problems herein described and other problems not discussed which are discoverable by a skilled artisan.

While the above description contains much specificity, these should not be construed as limitations on the scope of any embodiment, but as exemplifications of the presented embodiments thereof. Many other ramifications and variations are possible within the teachings of the various embodiments. While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

Thus the scope of the invention should be determined by the appended claims and their legal equivalents, and not by the examples given.

That which is claimed is:

1. A headset device comprising:
a first headphone;
a second headphone opposing the first headphone;
a headband connecting the first headphone and the second headphone;
a first headphone cover removably connect to the first headphone; and
a second headphone cover removably connected to the second headphone opposing the first headphone cover;
wherein each of the first headphone cover and the second headphone cover comprise:
a rear portion having an engagement portion adapted to engage a mount portion of a respective one of the first headphone or second headphone to allow for a respective one of the first headphone cover or second headphone cover to be secured to a respective one of the first headphone or second headphone, and
a passageway, sized to receive a temple tip of an eyeglasses frame, formed through a top portion and extending through a first side portion.

2. The headset device according to claim 1 wherein the passageway extends through the entirety of the top portion from the first side portion to a second side portion.

3. The headset device according to claim 1 wherein each of the first headphone cover and the second headphone cover includes an outer perimeter and an inner perimeter, and
wherein the passageway further comprises a forward passage formed to extend from the outer perimeter of the first side portion to the inner perimeter of the first side portion.

4. The headset device according to claim 3 wherein the passageway further comprises a rear passage formed to extend from the inner perimeter of a second side portion to the outer perimeter of the second side portion.

5. The headset device according to claim 1 further comprising:
a structural member, sized to receive a temple tip of an eyeglasses frame, disposed within the passageway.

6. The headset device according to claim 5 wherein the structural member extends through an entirety of the passageway from the first side portion to a second side portion.

7. The headset device according to claim 6 wherein the passageway comprises a forward passageway formed to extend from the outer perimeter of the first side portion to the inner perimeter of the first side portion;
wherein the passageway comprises a rear passage formed to extend from the inner perimeter of the second side portion to the outer perimeter of the second side portion; and further comprising:
a structural member cover to overlie the structural member and extend between the inner perimeter of the first side portion and the inner perimeter of the second side portion.

8. The headset device according to claim 1 further comprising a temple tip guide, having a size substantially similar to the passageway, extending outwardly from an outer perimeter of the first side portion of each of the first and second headphone covers.

9. The headset device according to claim 8 wherein the temple tip guide has a tapered end.

10. A headphone cover comprising:
a rear portion having an engagement portion adapted to engage a mount portion of a headphone to allow for the headphone cover to be secured thereto, and
a passageway, sized to receive a temple tip of an eyeglasses frame, formed through a top portion and extending through a first side portion.

11. The headphone cover according to claim 10 wherein the passageway extends through the entirety of the top portion from the first side portion to a second side portion.

12. The headphone cover according to claim 10 further comprising:
a structural member, sized to receive a temple tip of an eyeglasses frame, disposed within the passageway.

13. The headphone cover according to claim 12 wherein the structural member extends through an entirety of the passageway from the first side portion to a second side portion.

14. The headphone cover according to claim 10 having an outer perimeter and an inner perimeter, and
wherein the passageway further comprises:
a forward passage formed to extend from the outer perimeter of the first side portion to the inner perimeter of the first side portion, and
a rear passage formed to extend from the inner perimeter of a second side portion to the outer perimeter of the second side portion.

15. The headset device according to claim 10 further comprising a temple tip guide, having a size substantially similar to the passageway, extending outwardly from an outer perimeter of the first side portion of each of the first and second headphone covers.

16. A headset device comprising:
a first headphone further comprising:
a first speaker;
a second headphone, opposing the first headphone, further comprising:
a second speaker;
a headband connecting the first headphone and the second headphone;
a microphone boom connected to one of the first or second headphones;
a microphone connected to an end portion of the microphone boom, wherein the microphone boom is moveable so that the microphone is positionable adjacent to a user's mouth; and
a first headphone cover removably connect to the first headphone; and
a second headphone cover, opposing the first headphone cover, removably connected to the second headphone,
wherein each of the first headphone cover and the second headphone cover comprise:
a rear portion having an engagement portion adapted to engage a mount portion of either the first headphone or second headphone to allow for one of the first headphone cover or second headphone cover to be secured thereto,
a passageway, sized to receive a temple tip of an eyeglasses frame, formed through a top portion and extending through the entirety of a top portion from a first side portion to a second side portion, and
a structural member disposed within the passageway and sized to receive a temple tip of an eyeglasses frame.

17. The headset device according to claim 16 wherein each of the first headphone cover and the second headphone cover have an outer perimeter and an inner perimeter and the passageway further comprises:
a forward passage formed through the top portion and extending from the outer perimeter of the first side portion to the inner perimeter of the first side portion, and
a rear passage formed through the top portion and extending from the inner perimeter of the second side portion to the outer perimeter of the second side portion.

18. The headset device according to claim 17 wherein the structural member extends through an entirety of the passageway from the first side portion to the second side portion.

19. The headset device according to claim 16 further comprising a temple tip guide, having a size substantially similar to the passageway, extending outwardly from an outer perimeter of the first side portion of each of the first and second headphone covers.

20. The headset device according to claim 19 wherein the temple tip guide has a tapered end.
